(19) United States
(12) Patent Application Publication
(10) Pub. No.: US 2026/0221568 A1
(43) Pub. Date: Jul. 30, 2026

(54) BATTERY STORAGE SYSTEM FOR AN AUTOMOBILE

(71) Applicant: SABIC GLOBAL TECHNOLOGIES B.V., Bergen op Zoom (NL)

(72) Inventor: Carlos Pereira Cadena, Putnam Valley, NY (US)

(21) Appl. No.: 19/141,499

(22) PCT Filed: Dec. 18, 2023
(86) PCT No.: PCT/EP2023/086375

§ 371 Date: Jun. 20, 2025

(30) Foreign Application Priority Data
Dec. 20, 2022 (EP) 22215220.9

(51) Int. Cl. H01M 50/231; B60K 1/04; B60L 58/12; H01M 10/613; H01M 10/625; H01M 10/6556; H01M 10/6568; H01M 50/229; H01M 50/249

(52) U.S. Cl. CPC H01M 50/231; B60K 1/04; B60L 58/12; H01M 10/613; H01M 10/625; H01M 10/6556; H01M 10/6568; H01M 50/229; H01M 50/249; B60K 2001/0438

(57) ABSTRACT

A method of manufacturing a battery enclosure for an automobile, including forming a battery housing, including: (i) forming a unitary seamless liner that defines the battery storage cavity, and storage cavity facing coolant channels, the liner is optionally: compression molded; injection molded; or thermoformed, which includes heating a continuous and seamless plastic sheet, attaching via vacuum adsorption the plastic sheet to an inner surface of a mold that is shaped as the battery storing cavity, and cooling the plastic sheet; (ii) providing an outer shell that is optionally: (a) inductive for charging the battery cells within the enclosure; and (b) configured for transmission of radio-frequency signals therethrough; (iii) filling the core cavity with foam; forming coolant inlet and coolant outlet ports through the housing; (v) forming an electronics feed-through port through the housing; and releasably connecting a lid to a housing opening, thereby define the enclosure.

### BACKGROUND

The embodiments are directed to a battery storage system for an automobile.

Electrified vehicles differ from conventional motor vehicles because electrified vehicles are selectively driven using one or more electric machines powered by a battery pack. The electric machines can drive the electrified vehicles instead of, or in addition to, an internal combustion engine. Example electrified vehicles include hybrid electric vehicles (HEVs), plug-in hybrid electric vehicles (PHEVs), fuel cell vehicles (FCVs), and battery electric vehicles (BEVs).

The battery pack is a relatively high-voltage traction battery that selectively powers the electric machines and other electrical loads of the electrified vehicle. The battery pack can require cooling or heating. The battery pack includes arrays of interconnected battery cells that store energy for powering the electrical loads. The arrays are typically housed within an enclosure.

Composite enclosure solutions for storing batteries can utilize multiple plies of oriented glass and carbon fibers, metal stampings or thick plastic structures. Fabrication technologies for such enclosures allow for a limited build-series and are difficult to scale up.

### SUMMARY

Disclosed is a method of manufacturing an enclosure for enclosing batteries in an automobile, the method including: forming a housing that has housing walls including a bottom wall, first and second sidewalls that extend upwardly from the bottom wall to a top end of the housing, and first and second end walls that extend upwardly from the bottom wall to the top end, wherein the top end defines a housing opening, and wherein each of the housing walls has an inner surface such that the housing defines a storage cavity for storing battery cells, and an outer surface, and the inner and outer surfaces are spaced apart from each other to define a core cavity, wherein forming the housing comprises: (i) forming a liner that is a unitary seamless liner that defines the inner surface of each of the housing walls and forms the storage cavity, and coolant channels that face the storage cavity and that are fluidly sealed from the storage cavity, wherein the coolant channels are formed along the inner surface of one or more of the housing walls, wherein: the liner is one of: compression molded; injection molded; or thermoformed, which includes heating a continuous and seamless plastic sheet, attaching via vacuum adsorption the plastic sheet to a mold that is shaped as the storage cavity, and cooling the plastic sheet; (ii) providing an outer shell that defines the outer surface of each of the housing walls, wherein the outer shell is one or more of: (a) inductive for charging the battery cells within the enclosure; and (b) configured for transmission of radio-frequency signals therethrough; (iii) filling the core cavity with foam; (iv) forming coolant inlet and coolant outlet ports are through the housing, whereby coolant is configured for being transported through the coolant channels; (v) forming an electronics feed-through port through the housing; and releasably connecting a lid to the housing opening, thereby define the enclosure. The liner can be a material capable of withstanding direct flame exposure, that is, flame resistant, preferably with a UL94 V0 rating at its minimum thickness. The foam between the liner and the outer cladding can be a flame retardant or inherently flame-resistant foam, e.g., silicone foam.

### BRIEF DESCRIPTION OF THE DRAWINGS

FIG. 1 provides a side view of a battery pack mounted under a car, according to the embodiments;

FIG. 2 provides a bottom view of the battery pack of FIG. 1;

FIG. 3 schematically shows a system for thermally controlling the battery pack, according to the embodiments;

FIG. 4 illustrates a perspective view of a battery pack from the powertrain of FIG. 3;

FIG. 5 illustrates a section taken along line III in FIG. 4;

FIG. 6 illustrates the section of FIG. 5 without a cover, batteries or a coolant channel cover;

FIG. 7 is a perspective view of the battery pack enclosure that may be manufactured in, according to the embodiments;

FIG. 8 shows coolant pipes for cooling battery cells in the enclosure, according to the embodiments;

FIG. 9 shows a cross-sectional view of a battery cell enclosure of FIG. 7, according to the embodiments;

FIG. 10 shows coolant channels formed into the liner of the enclosure, according to the embodiments;

FIG. 11 shows a process of forming a liner, according to the embodiments; and

FIG. 12 is a flowchart showing a method of manufacturing a battery cell enclosure, according to the embodiments.

### DETAILED DESCRIPTION

In the following text, the terms “battery”, “cell”, and “battery cell” may be used interchangeably and may refer to any of a variety of different cell types, chemistries and configurations including, but not limited to, lithium ion (e.g., lithium iron phosphate, lithium cobalt oxide, other lithium metal oxides, etc.), lithium ion polymer, nickel metal hydride, nickel cadmium, nickel hydrogen, nickel zinc, silver zinc, or other battery type/configuration. The term “battery pack” as used herein refers to multiple individual batteries contained within a single piece or multi-piece housing, the individual batteries electrically interconnected to achieve the desired voltage and capacity for a particular application. The term “electric vehicle” as used herein may refer to an all-electric vehicle, also referred to as an EV, a plug-in hybrid vehicle, also referred to as a PHEV, or a hybrid vehicle, also referred to as a HEV, where a hybrid vehicle refers to a vehicle utilizing multiple propulsion sources one of which is an electric drive system.

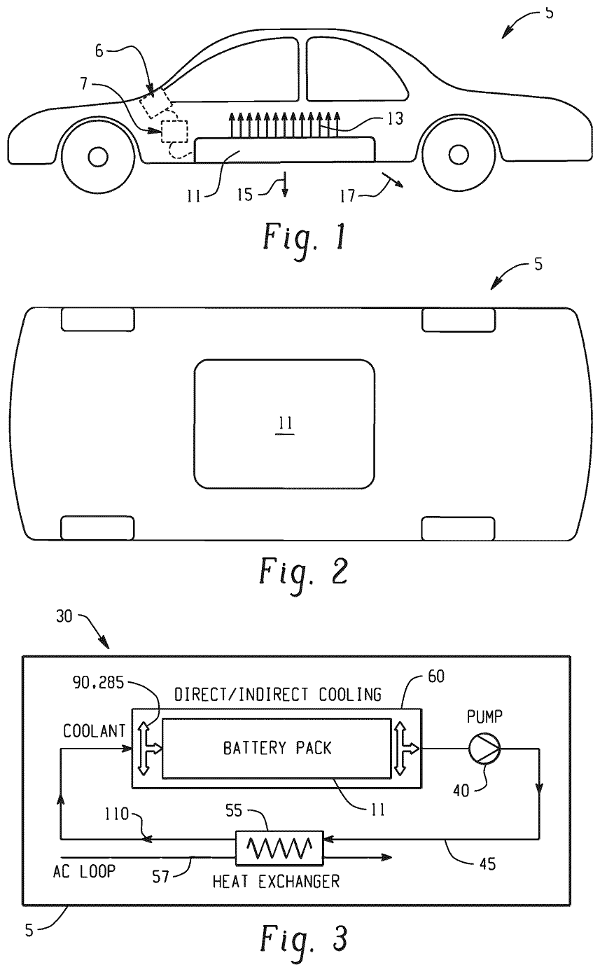

FIGS. 1 and 2 provide side and bottom views, respectively, of a automobile 5 with a battery pack 11 mounted underneath the automobile 5. The automobile 5 may have an information readout 6, such as a dashboard information display, which is operationally coupled with a car controller 7. The controller 7 may be configured to determine an amount of power remaining within the battery pack 11 and provide, on the readout 6, an indicator of the amount of power remaining within the battery pack 11. The figures show heat flowing out of the car in directions 13, 15 and 17. The battery pack configuration shown in FIGS. 1 and 2 is simply for illustration purposes and that the invention is equally applicable to other configurations. In general, the location of the battery pack is based on a number of design criteria including, but not limited to, battery pack size and weight to achieve the desired performance, cell choice, distribution of the battery pack weight to achieve the desired vehicle performance, constraints due to vehicle size, location of vehicle undercarriage support frame members, passenger compartment size and configuration (e.g., number of seats), configuration of the trunk and engine compartments, etc. Additionally, in some vehicles multiple battery packs may be used. The use of a multiple pack design may be due to the use of multiple drive motors, or simply as a means of achieving the desired weight distribution.

Referring to FIG. 3, an integrated system 30 may be provided within the automobile 5 for thermally controlling the battery pack 11. The integrated system 30 may include the battery pack 11 housed within an enclosure 60. A pump 40 may pressurize a coolant flow 110 through piping 45 external to the enclosure 60 through channels 90 or pipes 285 (discussed in greater detail, below) within the enclosure 60. The coolant 110, carrying heat discharged from the battery pack 11, may be removed from the coolant 110 via a heat exchanger 55 that part of an air conditioning loop 57 onboard the automobile 5. With regard to cooling of the battery pack 11, the heat generating element is inside the enclosure are battery cells and the heat is driven out continuously to maintain the ideal range of operation, e.g., positive 20 degrees Celsius to positive 39 degrees Celsius. An advantage of the enclosure 60 of the disclosed embodiments is that it isolates the interior battery pack 11 from exterior influences, e.g., excessive heat or cold, and thus allows for tighter thermal regulation.

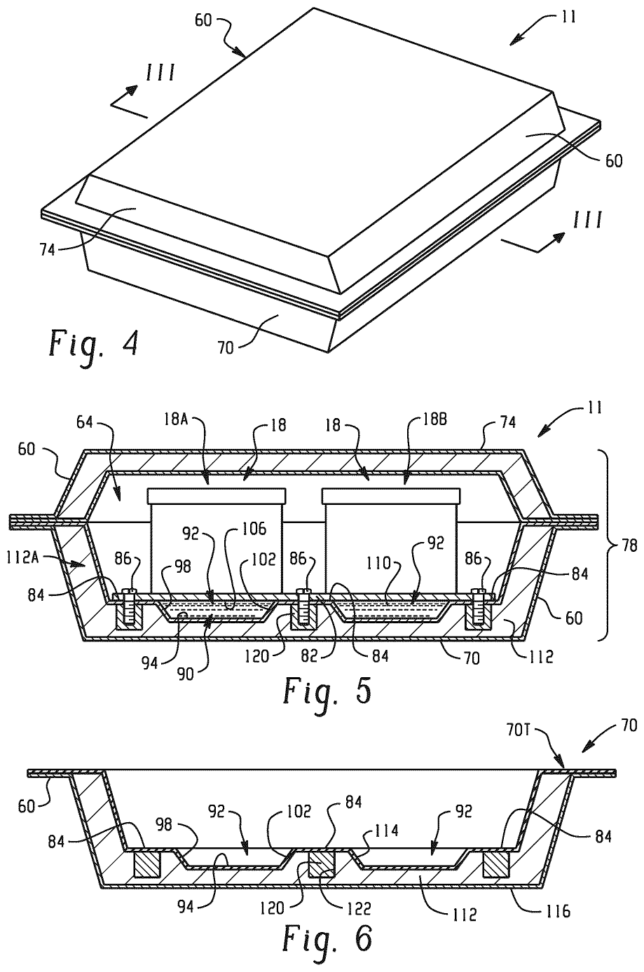

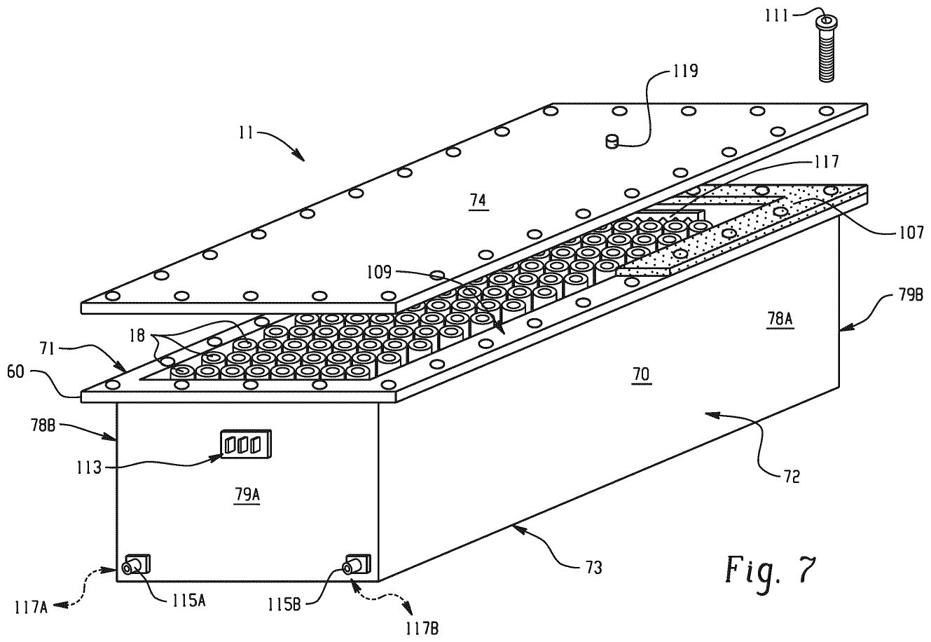

Referring now to FIGS. 4 and 5, additional aspects of the battery pack 11 are shown, which includes the enclosure 60 providing an interior area or storage cavity 64 that houses the battery cells 18. The enclosure 60 can house two of the battery cells 18 within the storage cavity 64. The cells 18 are in adjacent arrays 18A, 18B. In other examples, the enclosure 60 can house more than two, or less than two, of the battery arrays of multiple cells 18 within the storage cavity 64. The enclosure 60 can include a tray or lower housing 70 and a lid or upper housing 74 that rests on a top end 70T of the lower housing 70. The lower housing 70 and the upper housing 74 can each provide a portion of one of the sidewalls 78 and end walls 79 of the enclosure 60. Alternatively, the sidewalls 78 and end walls 79 are provided entirely by the lower housing 70 (see FIG. 7), in which case the tray may be referred to generally as a housing. Within the storage cavity 64, the battery cells 18 can rest upon a channel cover 82, which can be a thermal exchange plate, which is supported upon support surfaces 84 provided by the lower housing 70. Mechanical fasteners 86 can secure the channel cover 82 to the lower housing 70. Although described as the mechanical fasteners 86, other types of fastening devices could be used. The battery cells 18 can be secured to the channel cover 82 utilizing other mechanical fasteners (not shown). The channel cover 82 can be a metal or metal alloy. In one specific example, the thermal exchange plate is aluminum. The channel cover 82, and other examples, could be a material other than metals or metal alloys that is selected to promote thermal conduction. In one specific example, the thermal exchange plate is aluminum.

A thermal interface material (TIM) could be positioned between the battery cells 18 and the channel cover 82. The TIM can help to maintain thermal contact between the battery cells 18 and the channel cover 82. The TIM may be a pre-cured sheet, a non-curing liquid, a curing liquid, a gel, or another type. The TIM may be silicone-based with conductive fillers, acrylic-based with conductive fillers, or another type.

The lower housing 70 can provide a portion of a coolant channel 90 associated with the battery cells 18. The lower housing 70 includes a recessed area 92 to provide the coolant channel 90. The recessed area 92 can have a trapezoidal cross-sectional profile. Alternatively, the coolant channels 90 can have a U-shape or V-shape cross-sectional profile. The recessed area 92 can be recessed relative to the support surfaces 84 that interface with the channel cover 82. The recessed area 92 can be provided by a bottom floor 94 and opposing sidewalls 98 and 102. The recessed area 92 may not extend to the sidewalls and end walls 78, 79 of the lower housing 70, or it may extend to the sidewalls and end walls 78, 79. Extending the recessed area 92 to the sidewalls and end walls 78, 79 can provide a coolant channel that interfaces with a bottom of the battery cells 18, as well as a lateral side of the battery cells 18. In the assembled battery pack 11, the channel cover 82 covers the recessed area 92 to provide top surface 106 of the coolant channel 90. In particular, the channel cover 82 can extend across the coolant channel 90 from the sidewall 98 to the sidewall 102.

Top and bottom, for purposes of this disclosure, are with reference to the orientation of the battery pack shown in the figures. Other orientations for the battery pack 11 are possible, some of which could cause the top surface 106 to be a bottom surface of the coolant channel 90, and the bottom floor 94 to be a top surface of the channel. Thus, top and bottom should not be considered to limit the battery pack 11 to a particular orientation.

A liquid or gas coolant 110 can move through the coolant channel 90. The support surfaces 84 could include a seal, such as an ethylene propylene diene monomer (EPDM) rubber seal, that is compatible with a coolant 110. This configuration blocks the coolant 110 from moving between the support surfaces 84 and the channel cover 82. The seal could be a press-in-place seal, a carrier gasket seal, a foam seal, an RTV silicone seal, etc. The coolant 110 can exchange thermal energy with the channel cover 82. The coolant 110 can takes on thermal energy from the channel cover 82, which can be generated during operation of the battery cells 18. The coolant 110 can cool the battery cells 18 due to movement of the thermal energy from the battery cells 18, through the channel cover 82, to the coolant 110 within the coolant channel 90. The coolant channel 90 can extend beneath both of the battery cells 18 within the storage cavity 64. Accordingly, the coolant 110 that is moved through the coolant channel 90 can pass beneath both of the battery cells 18 of the battery pack 11. The coolant channel 90 could be divided into separate channels. That is, for example, the coolant channel 90 could include a first channel associated with one of the battery cells 18 and a separate, second channel associated with the other array.

Referring now to FIG. 6 with continuing reference to FIG. 5, the lower housing 70 can be a composite structure of the enclosure 60. In particular, the lower housing 70 can include a core 112 sandwiched in a core cavity 112A between an inner layer or inner surface, otherwise referred to as a liner 114, and an outer layer or outer surface 116, otherwise referred to as an outer shell. A least one insert 120 can be disposed between the between the inner layer 114 and the outer layer 116 of the lower housing 70. Both the lower housing 70 and the upper housing 74 can be composite structures. Alternatively, one of the tray or the lid is a composite structure, and the other of the tray or the lid is not a composite structure. Yet alternatively, another area of the enclosure 60 is a composite structure, such as a sidewall of the enclosure 60 that is separate from the lower housing 70 and the upper housing 74. The core 112 can be foam. The foam can be a closed-cell high-density foam. Other example materials suitable for use as the core 112 can include honeycomb structures, balsa wood, meta-aramid materials, such as those sold under the tradename Nomex®, etc. The core 112 can be produced by a variety of methods, which may depend on a material composition of the core 112. Exemplary methods can include extruding the core 112 and molding the core 112.

Although the inner layer 114 and the outer layer 116 are depicted as a singular layer, additional layers could be utilized to, for example, increase a strength of the lower housing 70. Further, the material composition of the outer layer 116 may differ from the material composition of the inner layer 114. For example, the inner layer 114 could have a material composition suitable for interfacing with the storage cavity 64 of the battery pack 11, and the outer layer 116 could have a material composition suitable for interfacing with an outside environment surrounding the battery pack 11. The outer layer 116 could be, for example, a high temperature resistant epoxy, such as epoxy sold under the trade/name of Duralco™ 4460.

In this example, the insert 120 is disposed within a slot 122 of the core 112. The insert 120 can be a polymer-based material. In particular, the exemplary insert 120 is an ultra-high molecular weight (UHMW) polyethylene material. The insert 120 is a single, monolithic structure in this example. In another example, the insert 120 has a plurality of separate, individual inserts. In other examples, the insert 120 is a metal or metal alloy. The material and shape of the insert 120 can be selected to reduce or eliminate creep and to maintain a seal between the channel cover 82 and the lower housing 70.

In the assembled battery pack 11 of FIG. 5, the mechanical fasteners 86 extend through the inner layer 114 to threadably engage with an area of the insert 120. The engagement of the mechanical fasteners 86 with the insert 120 clamps the channel cover 82 against the support surfaces 84 of the lower housing 70. The insert 120, in other examples, could be used to secure other battery components instead of, or in addition to, the channel cover 82.

In the cross-section through the coolant channel 90 shown in FIG. 5, the lower housing 70 provides a portion of a perimeter of the coolant channel 90, and the channel cover 82 provides the remaining portions of the perimeter of the coolant channel 90. The entire perimeter of the coolant channel 90 is thus provided by the lower housing 70 and the channel cover 82.

FIG. 7 is a perspective view of the battery pack 11 configured as a multi-piece enclosure in which the lower housing 70 has a U-shaped cross section and as indicated can be referred to as a lower housing, or generally, a housing. The upper housing 74 in FIG. 7 is planar and can be referred to as an upper housing. The lower housing 70 defines a top opening 71 and includes walls, generally referred to as 72, including a bottom wall 73, first and second sidewalls 78A, 78B that extend between the bottom wall 73 and the top opening 71, and first and second end walls 79A, 79B that extend between the bottom wall 73 and the top opening 71. As indicated, the embodiments are not limited to a particular number of cells, a specific battery chemistry or style, or a particular interconnect configuration.

To minimize battery and interconnect particulate and non-particulate (e.g., vapor) contamination, lower housing 70 and/or upper housing 74 are each fabricated from a material or materials that are impermeable to water and water vapor, and preferably impermeable in general to other liquids and gases. Additionally, as the housing members (e.g., the lower and upper housings 70, 74) are intended to contain a plurality of cells, in some instances hundreds or thousands of cells, the housing members can be fabricated from materials capable of handling the weight of the cells for the intended application. For example, materials utilized for one or both housing members may include a metal (e.g., aluminum, an aluminum alloy, steel, etc.) or a plastic or a high strength, lightweight composite such as a carbon composite. In some instances, it may be necessary to coat the material comprising the housing with an impermeable layer, e.g., a metal layer deposited on a plastic housing structure. Such an impermeable layer may be added using any of a variety of well-known coating techniques such as vapor deposition. The use of an additional impermeable coating allows the selection of the material used for the housing members to be based on the material's mechanical and electrical properties (e.g., high strength, low weight, high structural rigidity, electrically non-conductive, etc.), rather than its liquid and gas impermeability.

To achieve the desired enclosure impermeability, a compressible and impermeable seal, or sealing gasket 107, which may be elastomeric, is interposed between the complimentary and mating surfaces of lower housing member 70 and upper housing member 74. Those of skill in the art will recognize that there are countless materials from which the gasket 107 can be fabricated, exemplary materials including, but not limited to, polyurethanes, polychloroprenes, rubber-edged composite materials, coated (e.g., PVC coated) polymers, uncoated polymers, synthetic rubbers (e.g., butyl rubber), and acrylic impregnated polyurethanes.

In the exemplary battery pack 11, sealing gasket 107 is positioned between a flange 109 of lower housing member 70 and a surface of the flat, upper housing member 74. In configurations utilizing a non-flat upper housing member (FIGS. 4-6), the upper housing member can include a flange that is complimentary to flange 109. The gasket 107 may be flat as shown, or utilize an alternate configuration (e.g., a circular cross-section prior to compression). The battery pack 11 can include implements, for example a plurality of bolts 111, for compressing the gasket 107 and holding together the housing members. Bolts 111 may also be used to attach enclosure 60 to the mounting structure of the intended application, for example to the mounting bay of an electric vehicle.

To protect cells 18 from environmentally induced degradation, all connections to the internal volume of enclosure 60 can be hermitically sealed. Thus, in the exemplary battery pack 11, electrical connections (or electronics feed through port) 113 are hermitically sealed to lower housing member 70 as are the coolant ports 115A, 115B connected to coolant inlet and outlet lines 117A, 117B used to couple an active cooling system to the battery pack.

Although a variety of different techniques may be used to collect and remove water vapor from the battery pack, a desiccant can be used to remove water vapor from within enclosure 60 via absorption and/or adsorption. In battery pack 11, the desiccant is held within a container 117 mounted within the enclosure. The battery pack may also include a pressure management system that ensures that the pressure differential between the inner volume of the enclosure and the outside environment stays within a predetermined range. In the battery pack 11, a pressure management system is included that can have one or more pressure relief valves 119. Pressure relief valve(s) 119 ensures that the pressure differential between the inner enclosure volume and the outside environment does not become large enough to cause structural damage to the enclosure. Pressure differentials may be caused by the battery pack being moved to a different altitude and thus subjected to a different external pressure, or may arise due to component out-gassing, battery cell venting, temperature changes, etc. To minimize the risk of water vapor entering the enclosure via the relief valve, the valve has preset relief points (i.e., set points). The pressure relief set point may be different depending upon the direction of release, i.e., inward versus outward venting, or may utilize the same set point. A typical pressure relief set point is 1 psi in either direction.

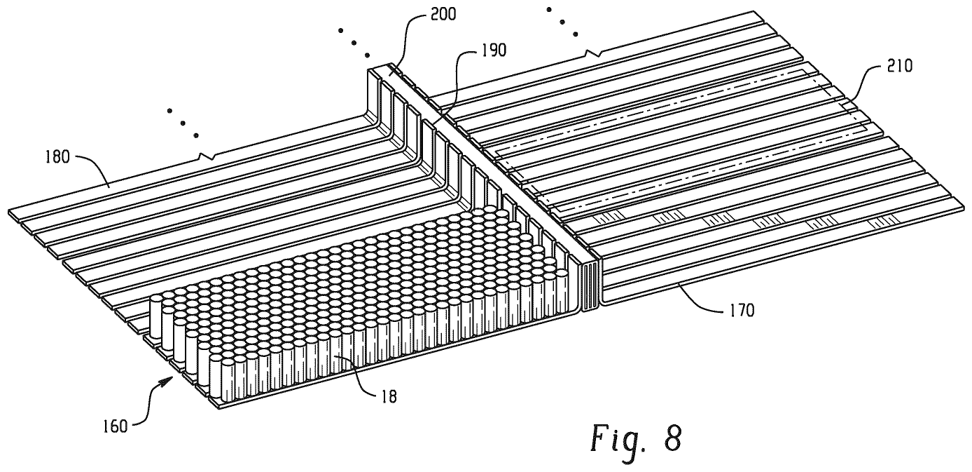

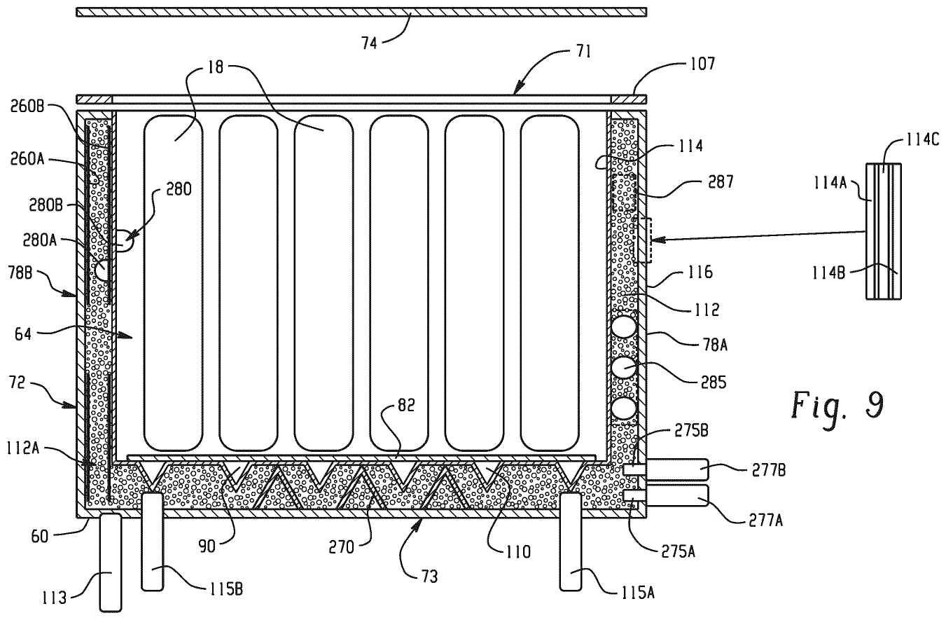

FIG. 8 illustrates a heat transfer system 160 that may be inserted into the lower housing 70 and utilized in addition or in lace of the coolant channels disclosed above. The system 160 may utilized heat pipes 170 that in one embodiment have an L-shape as shown. An evaporation surface 180 can be oriented essentially horizontally (e.g., inside a battery pack of an electric vehicle) and a condensation surface 190 can be oriented essentially vertically. Cells 18 (e.g., lithium-ion cells of the 18650-type) are shown positioned on one of the heat pipes. The interface between the cells and the heat pipe is by conductive thermal contact requiring a TIM. For example, the heat pipe can have multiple adjacent parallel heat sections attached to each other (e.g., by welding). The cells can have more or fewer cells than illustrated in this example, and/or the cells can be arranged in a different configuration. For clarity, a subset of the cells is shown in FIG. 9. Implementations of energy storage systems can have any number of cells.

The energy storage system 160 has at least one heat transfer channel 200 that is in thermal exchange with the heat pipes 170. Coolant fluid can be supplied to the system 160 as disclosed above. For example, the energy storage system described here can be incorporated as a battery pack in an electric (or hybrid) vehicle, and a cooling system external to the battery pack can then cool the fluid from the heat transfer channel, thereby removing heat from the cells.

In FIG. 8, the heat transfer channel 200 is provided in the middle of the energy storage system 160, and the cells 18 can then be positioned in rows on each side of the channel, for example in a location 210. The condensation ends/surfaces of the respective heat pipes are positioned so that they are against the sides of the heat transfer channel. Accordingly, the heat pipes extend from the channel in opposite directions. The heat pipes 170 on which the cells 18 are positioned are shown to include six parallel heat pipe sections. Solely as an example, each of such sections can contain more than a dozen separate internal channels, each of which individually operates according to the principle of a heat pipe.

Turning to FIG. 9, additional aspects of the enclosure 60 of FIG. 7 are disclosed according to the embodiments. The enclosure 60 includes the lower housing 70, or housing. The top opening 71, bottom wall 73 and first and second sidewalls 78A, 78B are shown. Each of the walls 72 the inner surface 114, such that the lower housing 70 defines the storage cavity 64 for storing the battery cells 18. In FIG. 9, the lower housing 70 defines a U-shaped profile. The walls 72 have the outer surface 116 that defines the outer shell that is spaced apart from the inner surface 114 to define the core cavity 112A therebetween.

The lower housing 70 includes the foam core 112 in the core cavity 112A, between the inner 114 and outer surfaces 116. The core 112 can be formed as a rigid foam. The core 112 can be formed of an open cell foam or a closed cell foam. The core 112 can be formed of polyurethane foam. The core can be formed of a flame-retardant material such as foam. The core can be formed of ULTEM, manufactured by the applicant. The core 112 may be is 5-15 mm thick.

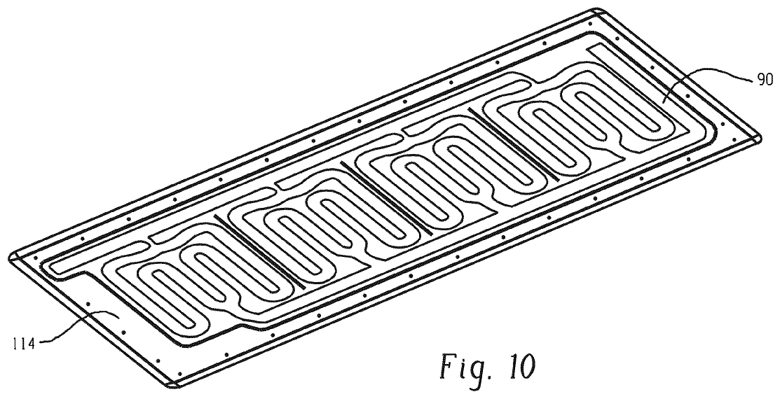

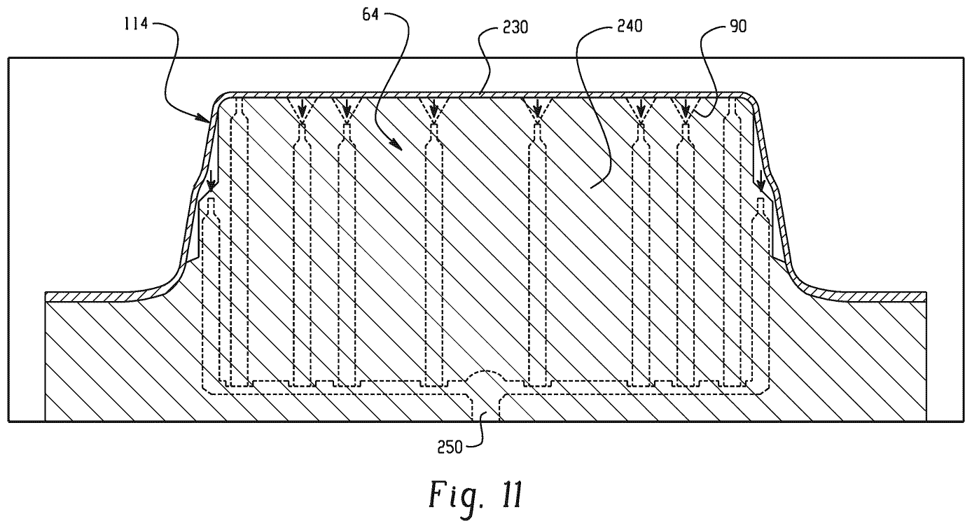

With reference to both FIGS. 9 and 10, cavity facing coolant channels 90 are formed in the liner 114 and sealed from the battery storage cavity 64. The channels 90 may be formed only in the bottom wall 73 of the enclosure 60. In one embodiment, each of the liner surface 114 along each of the enclosure walls 72 may define the cavity facing coolant channels 90. The channels 90 may have a U-shape or a V-shape profile.

The coolant channels 90 may be covered by the channel cover 82. The channel cover 82 can be thermally conductive and electrically non-conductive. The channel cover 82 can be metalized plastic. Coolant 110 within the coolant channels may be glycol or a glycol-water mixture.

Turning to FIG. 11, a unitary seamless liner 114 can be compression molded, injection molded or thermoformed. Thermoforming includes heating a continuous and seamless plastic sheet 230 to its softening point, and attaching the plastic sheet 230, via vacuum adsorption, to an inner surface of a mold 240 that is shaped as the battery storing cavity 64, using vacuum suction via vacuum suction ports 250 in the mold 240 to form the storage cavity 64, and, e.g., the coolant channels 90 and cooling the plastic sheet 230. Similar processes are applied to form refrigerator cabinets. The liner 114 can be formed of a polymer. The liner 114 can be formed of a thermoset or a thermoset composite. The liner 114 can be formed of a flame-resistant polypropylene. The liner 114 can be a flame-resistant polycarbonate. The liner can be formed of LEXAN, manufactured by the applicant. The liner can be formed of an intumescent plastic or have an intumescent coating. The liner 114 can be a material capable of withstanding direct flame exposure, that is, flame resistant, preferably with a UL94 V0 rating at its minimum thickness. The liner can be formed of a glass fiber content of 20-30% or higher. The liner 114 can be between 1 and 4 mm thick.

Turning back to FIG. 9, the outer shell 116 can be inductive for charging the battery cells 18 within the enclosure 60. The outer shell 116 can also be configured as a ground plane. The outer shell 116 can be configured for transmission of radio-frequency signals therethrough and may be configured to attenuate electromagnetic interference (EMI). The outer shell 116 can be formed of metal cladding, which can be a ferromagnetic metal. The outer shell 116 can alternatively be formed of a metalized plastic. The outer shell 116 may be formed of copper, nickel, aluminum, or steel. The outer shell 116 can be less than 10 mm thick and more specifically between 0.2-2.9 mm thick.

An outer layer, generally 260, of metalized plastic can be disposed within the core 112 and against the outer shell 116 as layer 260A or liner 114 as layer 260B.

The outer shell 116 or liner 114 can be formed as an ABA sandwich composite. The liner 114 may be a sandwich structure having a metal substrate, with a layer 114A that faces the core 112 a layer 114B that faces outwardly (e.g., into the storage cavity 64 for the liner 114 or outwardly from the enclosure 60 for the shell 116), and a layer 114C of metallized plastic therebetween. In one embodiment, the enclosure 60 can be galvanic and fire resistant.

An upper housing 74 (or lid or cover) may be releasably connected to the enclosure 60 at the housing opening 71. The upper housing 74 and lower housing 70 together may define the enclosure 60. The upper housing 74 may be is sealed to the lower housing 70 via the gasket 107.

The outer shell 116 can include insulation ports 275, including a core fill port 275A and a vent port 275B. Foam may be dispensed into the core cavity 112A via the fill port 275A, and any air therein can be expelled through the vent port 275B. Plugs 277A, 277B may be inserted into the core fill port 275A and vent port 275B after filling the core cavity 112A with the core material 112. The core 112 may be vacuum sealed upon being filled with core material 112. The foam 112 between liner 114 and outer cladding 116 can be a flame retardant or inherently flame-resistant foam, e.g., silicone foam.

The lower housing 70 can define the coolant ports, including a coolant inlet port 115A and a coolant outlet port 115B. From these ports 115A, 115B coolant 110 can be transported through the coolant channels 90.

The core 112 may be formed with a core support member 270 that can extend within the core cavity 112A between the outer shell 116 and the liner 114. The support member 270 may be configured to prevent buckling between the outer shell 116 and the liner 114. The core support member 270 may be one or more ribs. The liner 114 may be formed with a liner support implement 280, which can be support impressions 280A or protrusions 280B. The liner support implements 280 may be honeycomb shaped or may be formed of one or more ribs.

In one embodiment, cooling pipes and pipe arrays 285, a few of which are shown in FIG. 9, can be used for cooling, e.g., located underneath the liner 114, along any one or more of the walls 72. For simplicity the cooling pipe array 285 is shown under the liner 114 along a sidewall 78, but this not intended on limiting the scope of the embodiments. A condenser-evaporator cooling system is shown schematically as 287 can be utilized. For example, thermoelectric cooling, heat pipes and immersion cooling systems can be integrated into the liner/metal cladding sandwich structure. For simplicity the cooling system 287 is also shown schematically under the liner 114 along a sidewall 78A, but this not intended on limiting the scope of the embodiments.

Data may be transmitted through the enclosure 60 related to, e.g., health of the battery cells. A processor onboard the automobile 5 may receive the transmitted data, which may be displayed on a dashboard information display or other display, such as a smartphone. The electronics port 113 can be formed through the lower housing 70. This would be used, for example, to transfer power from the batteries to the car components that require power, such as drive motors.

In sum, the embodiments, adapt technology used for thermoforming or injection molding liners and polyurethane foams to make liners for battery enclosures. The embodiments can be scaled up to manufacture millions of units per year. Essentially, the embodiments provide a sandwich structure having an external metal cladding (steel or aluminum), a honeycomb or expanded or rigid foam core, and a flame retarded or intumescent plastic (PP or PC) inner liner. The liner can be a material capable of withstanding direct flame exposure, that is, flame resistant, preferably with a UL94 V0 rating at its minimum thickness. The foam between the liner and the outer cladding can be a flame retardant or inherently flame-resistant foam, e.g., silicone foam. Each can be millimeters thick. In one embodiment, the sandwich structure can be formed as the lower and upper parts of an enclosure which houses one or more electrical cells and forms a battery case. The embodiments provide an enclosure that is configured for fire containment, with thermal and electrical isolation of interior components such as battery cells, for EMI protection at low frequencies and electrical grounding of the enclosure. The embodiments utilize copper, aluminum, or steel as outer cladding, achieving a galvanic enclosure with the cover and allowing sealing of the periphery through use of elastomeric seals. The disclosed liner is a thin thermoformed or injection or compression molded shell which exhibits intumescent behavior, e.g., utilizing extrudable FR STAMAX™ or FR PPc with glass fiber content of 20-30% for higher rigidity. The liner can incorporate flow channels which can be closed at the top using an aluminum plate.

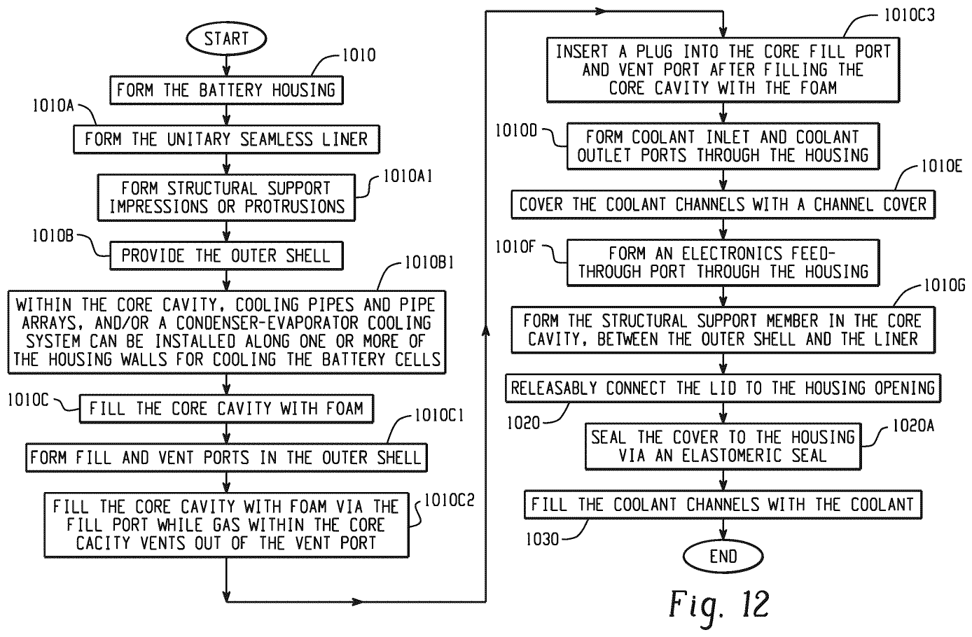

Turning to FIG. 12, a flowchart shows a method of manufacturing the enclosure 60. The order of the method steps provided herein is not intended on limiting the scope of the embodiments. As shown in block 1010, the method includes forming the lower housing 70. As indicated, the lower housing 70 has the bottom wall 73, first and second sidewalls 78A, 78B (collectively sidewalls 78) that extend upwardly from the bottom wall to the top end 70T of the lower housing 70, and first and second end walls 79A, 79B (collectively end walls 79) that extend upwardly from the bottom wall 73 to the top end 70T. The top end 70T defines the housing opening. Each of the housing walls has the inner surface 114 such that the housing defines the storage cavity 64 for storing battery cells 18. Each of the walls also includes the outer surface 116. The inner and outer surfaces are spaced apart from each other to define the core cavity 112A.

Additional aspects of forming the housing (block 1010) are disclosed in blocks 1010A-1010G. As shown in block 1010A, the method includes forming the unitary seamless liner 114. As indicated, the liner defines the inner surface of each of the housing walls and forms the battery storage cavity 64. The liner 114 also defines storage cavity facing coolant channels 90 that are fluidly sealed from the battery storing cavity 64, and which can have a U-shape or a V-shape profile. The coolant channels 90 are formed in one or more of the inner surfaces 114. The liner is one of: compression molded; injection molded; or thermoformed. Thermoforming includes heating a continuous and seamless plastic sheet, attaching via vacuum adsorption the plastic sheet to an inner surface of a mold that is shaped as the battery storing cavity, and cooling the plastic sheet.

The liner 114 can be a polymer. Alternatively, it can be a thermoset or a thermoset composite. Alternatively, it can be flame resistant polypropylene. Alternatively, it can be flame resistant polycarbonate. Alternatively, it can be formed of LEXAN. Alternatively, it can be an intumescent plastic or have an intumescent coating. Alternatively, it can be a glass fiber content of 20-30% or higher. The liner 114 can be a material capable of withstanding direct flame exposure, that is, flame resistant, preferably with a UL94 V0 rating at its minimum thickness. In one embodiment, it can be 1-4 mm thick. In a further embodiment, the liner 114 is combined with intumescence so as to limit fire propagation in case of battery thermal runaway, and a flame-retardant material or an inherently flame-resistant foam, e.g., silicone foam, is located between the liner 114 and the outer cladding 116.

One or more sockets 155 can be formed in the liner 114 which are configured to receive the battery cells 18. The sockets 155 may be formed by the coolant channels 90.

As shown in block 1010A1, forming the liner includes forming structural support impressions or protrusions 280A, 280B that are integral with the liner. As indicated, the structural support impressions or protrusions 280A, 280B of the liner 114 can be one or more ribs.

As shown in block 1010B, the method includes providing the outer shell 116. As indicated, the outer shell defines the outer surface of each of the housing walls and can be one or more of: inductive for charging the battery cells within the enclosure; and configured for transmission of radio-frequency signals therethrough. The outer shell 116 or liner 114 can be formed as an ABA sandwich composite. For example, the liner 114 can be a sandwich structure of metal having a core facing layer and an outer facing layer, and a layer of metallized plastic therebetween. Alternatively, a layer of metalized plastic 260A or 260B can be within the core cavity 112A, against the outer shell 116 or liner 114.

The outer shell 116 can be a ground plane. Alternatively, it can be configured to attenuate electromagnetic interference (EMI). Alternatively, it can be formed of metal cladding, and the metal cladding can be a ferromagnetic metal. Alternatively, it can be a metalized plastic. Alternatively, it can be copper, nickel, aluminum or steel. In one embodiment, it can have a thickness of less than 10 mm, or more specifically be between 0.2-2.9 mm thick.

As shown in block 1010B1, within the core cavity 112A, cooling pipes and pipe arrays 285, and/or a condenser-evaporator cooling system as the cooling system 287 can be installed along one or more of the housing walls 72 for cooling the battery cells 18. As shown in block 1010C, the method includes filling the core cavity 112A with foam. Additional aspects of filling the core cavity (at block 1010C) are disclosed in blocks 1010C1-1010C3. As shown in block 1010C1, the method includes forming fill and vent ports 275A, 275B in the outer shell 116. As shown in block 1010C2, the method includes filling the core cavity 112A with foam via the fill port 275A while gas within the core cavity vents out of the vent port 275B. As shown in block 1010C3, the method includes inserting plug 277A, 277B into the core fill port and vent port after filling the core cavity with the foam.

The core 112 can be a rigid foam. Alternatively, it can be an open cell foam or a closed cell foam. Alternatively, it can be a polyurethane foam. Alternatively, it can be flame retardant. Alternatively, it can be formed of ULTEM. In one embodiment, it can be 5-15 mm thick. In one embodiment, it can be vacuum sealed.

As shown in block 1010D, forming the lower housing 70 includes forming coolant inlet and coolant outlet ports 115A, 115B through the housing. From this configuration, coolant 110 can be transported through the coolant channels 90. As shown in block 1010E, the method includes covering the coolant channels 90 with a channel cover 82. The channel cover 82 can be thermally conductive and electrically non-conductive. Alternatively, the channel cover 82 can be metalized plastic.

As shown in block 1010F, the method includes forming an electronics feed-through port 113 through the housing. As shown in block 1010G, the method includes forming the structural support member 270 in the core cavity 112A, between the outer shell 116 and the liner 114. As indicated the structural support member 270 is configured to prevent buckling between the outer shell 116 and the liner 114. The structural support member 270 is either one or more ribs or forms a honeycomb shape.

As shown in block 1020, the method includes releasably connecting a upper housing 74 to the housing opening. This forms the enclosure 60. As shown in block 1020A the method includes sealing the upper housing 74 to the housing via an elastomeric seal. As shown in block 1030, the method includes filling the coolant channels with coolant 110. The coolant can be glycol or a glycol-water mixture.

As indicated, thermoforming of a liner can be performed similarly to thermoforming a cabinet for a refrigerator. Thermoforming is a process of heating a thermoplastic sheet to its softening point. The sheet is stretched across a single-sided mold and then manipulated. Then, it cools into the desired shape. Thermoforming methods include vacuum-forming, pressure-forming, and mechanical forming. In vacuum forming, a mold is opened, and a vacuum pressure involved for forming a sheet into a desired shape may be, in certain implementations, about 15 psi. Pressure forming adds a pressure box to a tooling package and utilizes both vacuum and positive air pressure. This process generates as much as three to four times the forming pressure as vacuum forming does. Therefore, fine details such as surface textures can be formed on the mold without incurring excessive extra costs. Vacuum forming is a type of thermoforming, however, under vacuum forming, the plastic conforms to the mold during forming. Vacuum forming utilized for plastic parts that need to be formed into cavities.

Materials that may be used for thermoforming can include ABS (Acrylonitrile Butadiene Styrene), which has good stiffness and impact strength and comes in different colors and textures. Acrylic (Polymethyl Methacrylate, Plexiglass or PMMA) is clear and abrasion-resistant and can be fabricated relatively easily and is available in impact-modified grades and also comes in many colors. HDPE (High-Density Polyethylene) is relatively resistant to impact as well as chemicals and it also has good cold-temperature properties. HIPS (High-Impact Polystyrene) is a low-cost material that forms relatively easily and is available in different colors. HMPWE (High Molecular Weight Polyethylene) has a relatively high impact strength, is chemical resistant and puncture resistant. KYDEX (PMMA/PVC blend) is relatively resistant to chemicals and heavy impacts and is available in different colors and textures. LEXAN is relatively flame-resistant, scratch-resistant, and can stand up to various types of weather. PC (Polycarbonate) has a relatively high impact strength, is clear and has a high-temperature resistance. Pennite (glass-filled nylon) is relatively strong, stiff and inexpensive. PEI (Polyetherimide, e.g. ULTEM) is a relatively high-temperature grade material, and it is autoclavable. PETG (Polyethylene Terephthalate Glycol) is clear and has relatively good impact strength. PP (Polypropylene) has relatively good chemical resistance, is rigid and has good impact strength. PVC (Polyvinyl Chloride) is a rigid material that is relatively strong and has good impact strength, and it is flame-retardant. Royalite is durable, has high impact strength and high tensile strength. RPET (Reprocessed Polyethylene Terephthalate) is clear and has a low cost. TPO (Thermoplastic PolyOlefin) has relatively good impact properties. Vinyl is durable, flame-resistant, and a good conductor of electricity. Thermoplastics are the final products that result from the thermoforming process. A benefit of thermoplastics is their tolerance to repeated activation, e.g., they can be reheated and reshaped, and they are recyclable. Further, due to the chemistry involved, thermoplastic materials exhibit the same characteristics as rubber and can have the same strength as aluminum. The temperature tolerance of thermoplastic materials varies and can range from 100 degrees F. (or less) to 600 degrees F. (or more). Thermoplastics function well as both electrical and thermal insulation, and they can be electrically conductive if metal or carbon is added.

It is to be appreciated that the features of each of the above disclosed embodiments may be combined into a single embodiment or selected ones of the features may be utilized in one or more embodiments without departing from the scope of the disclosure.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

1. A method of manufacturing an enclosure for enclosing batteries in an automobile,
the method comprising:
forming a housing that has housing walls including a bottom wall, and first and second sidewalls that extend upwardly from the bottom wall to a top end of the housing, and first and second end walls that extend upwardly from the bottom wall to the top end, wherein the top end defines a housing opening, and wherein each of the housing walls has an inner surface such that the housing defines a storage cavity for storing battery cells, and an outer surface, and the inner and outer surfaces are spaced apart from each other to define a core cavity,
wherein forming the housing comprises:
forming a liner that is a unitary seamless liner that defines the inner surface of each of the housing walls and thus the storage cavity, and that also defines coolant channels disposed adjacent to storage cavity which are configured to be fluidly sealed from the storage cavity, wherein the coolant channels are formed along the inner surface of one or more of the housing walls,
wherein the liner is one of: compression molded, injection molded, or thermoformed, and
wherein forming a liner includes heating a continuous and seamless plastic sheet, attaching via vacuum adsorption the continuous and seamless plastic sheet to a mold that is shaped as the storage cavity, and cooling the continuous and seamless plastic sheet;
providing an outer shell that defines the outer surface of each of the housing walls, wherein the outer shell is one or more of:
inductive for charging the battery cells within the enclosure; and
configured for transmission of radio-frequency signals therethrough;
filling the core cavity with foam;
forming coolant inlet and coolant outlet ports through the housing in sealed fluid communication with the coolant channels; and
forming an electronics feed-through port through the housing; and
releasably connecting a lid to the housing opening, thereby defining the enclosure.

2. The method of claim 1, wherein
filling the core cavity with the foam comprises:
forming a fill port and a vent port in the outer shell;
filling the core cavity with the foam via the fill port while gas within the core cavity is urged to vent out of the vent port; and
inserting plugs into the fill port and the vent port after filling the core cavity with the foam.

3. The method of claim 2, comprising
installing within the core cavity, cooling pipes and pipe arrays, and/or a condenser-evaporator cooling system along one or more of the housing walls for cooling the battery cells.

4. The method of claim 3, wherein:
forming the housing further includes forming a support member in the core cavity, between the outer shell and the liner, to prevent buckling between the outer shell and the liner; or
the structural support member is either one or more ribs or forms a honeycomb shape.

5. The method of claim 4, wherein:
the outer shell or the liner is formed as an ABA sandwich composite; or
the liner is a sandwich structure of metal having a core facing layer and an outer facing layer, and a layer of metallized plastic therebetween.

6. The method of claim 5, wherein:
the outer shell is one or more of:
a ground plane; or
configured to attenuate electromagnetic interference (EMI); or
formed of metal cladding; or
formed of the metal cladding that is a ferromagnetic metal; or
comprises a metalized plastic; or
comprises copper, nickel, aluminum or steel; or
less than 10 mm thick; or
0.2-2.9 mm thick.

7. The method of claim 6, wherein
a layer of metalized plastic is within the core cavity, against the outer shell or the liner.

8. The method of claim 7, wherein
each of the coolant channels defines a U-shape or a V-shape profile.

9. The method of claim 8, wherein:
forming the housing includes covering the coolant channels with a channel cover; and
wherein the channel cover is: thermally conductive and electrically non-conductive; or the channel cover is formed of metalized plastic.

10. The method of claim 9, comprising
filling the coolant channels with a coolant, and
wherein the coolant is glycol or a glycol-water mixture.

11. The method of claim 10, wherein
the enclosure is galvanic, and
the enclosure is fire resistant.

12. The method of claim 11, wherein:
the liner is one or more of:
a polymer; or
a thermoset or a thermoset composite; or
flame resistant polypropylene; or
flame resistant polycarbonate; or
formed of polycarbonate; or
comprises an intumescent plastic or has an intumescent coating; or
comprises a glass fiber content of 20-30% or higher; or
1-4 mm thick.

13. The method of claim 12, wherein:
the core cavity is one or more of:
filled with a rigid foam; or
filled with an open cell foam or a closed cell foam; or
filled with a polyurethane foam; or filled with flame retardant material; or
filled with polyetherimide; or
5-15 mm thick; or
vacuum sealed.

14. An enclosure formed by the method of claim 16.

15. An automobile comprising the enclosure of claim 14.

16. The method of claim 4, wherein
forming the liner further includes forming structural support impressions or protrusions integral with the liner.

17. The method of claim 7, wherein
the method includes sealing the lid to the housing via an elastomeric seal.

18. The method of claim 10, wherein one or more sockets are formed in the liner which are configured to receive the battery cells.

19. The enclosure of claim 14, comprising the battery cells therein.

20. The automobile of claim 15, comprising
a controller configured to determine an amount of power remaining within the battery cells in the enclosure and provide, on an information readout, an indicator of the amount of power remaining within the battery cells
